(19) United States
(12) Patent Application Publication
(10) Pub. No.: US 2026/0179258 A1
(43) Pub. Date: Jun. 25, 2026

(54) System and Method for Automated Camera Parameters

(71) Applicant: Eaigle Inc., Markham (CA)

(72) Inventors: Mahdi MARSOUSI, Maple (CA); Akshaya Kumar MISHRA, Whitby (CA); Amir HOSSEIN, North York (CA)

(73) Assignee: Eaigle Inc., Markham, ON (CA)

(21) Appl. No.: 18/990,166

(22) Filed: Dec. 20, 2024

(51) Int. Cl. G06T 7/80; G06T 15/08; H04N 13/243; H04N 13/246

(52) U.S. Cl. CPC G06T 7/85; G06T 15/08; H04N 13/246; G06T 2207/10028; G06T 2207/30244; H04N 13/243

(57) ABSTRACT

A system and method for camera calibration for cameras deployed at monitored areas. The method includes obtaining a trained model, the trained model having been trained using a neural radiance field, the trained model back projects pixels in a camera image into a 3D coordinate system associated with a monitored area; and using the trained model to generate a set of calibration parameters.

### TECHNICAL FIELD

The following generally relates to automated camera parameters, including calibration and placement, in particular to automated camera calibration and placement or positioning, for example, using a backward neural radiance field (NeRF).

### BACKGROUND

Tracking objects in retail and logistic environments is garnering increasing attention due to its potential for loss prevention, enhanced workflow efficiency, and expedited service delivery [2]. The utilization of camera data for object tracking has ushered in a new era, as it has proven to be a more dependable data source compared to other sensory systems such as Bluetooth or Wi-Fi tracking devices. Cameras also offer cost savings in terms of maintenance and installation expenses, which would otherwise be incurred with tracking devices.

It has also been observed that the origins of optimal camera placement trace back to the art gallery problem. Given an indoor setting with a floor plan, their work aims to optimally place a certain number of cameras in designated regions to cover as much of the floor as possible. Binary integer programming formulation of this problem usually is NP-Complete. Due to this reason the optimal solution requires impractical amounts of time and resources. Numerous approximate optimization methods have been proposed to circumvent this limitation. Hörster and Lienhart [9], presented an adaptive greedy algorithm that works by creating a rank-matrix for all the possible camera locations. The rank is calculated as the total number of control points covered by each camera pose. The algorithm iteratively picks a camera pose with the highest rank until the required number of cameras are placed. Greedy algorithms like this tend to ignore the combinatorial aspect of the camera placement problem.

Moreover, the approximate optimization methods are found to try to uniformly search the solution space without having to go through all the combinations. Due to this reason, they are fast, but, they may fail to find the global optimal solution and often end up in local optimal.

### SUMMARY

The following describes methods and systems for automating camera calibration and for automating camera placement.

In one aspect, there is provided a method of camera calibration for cameras deployed at monitored areas, the method comprising: obtaining a trained model, the trained model having been trained using a neural radiance field, the trained model back projects pixels in a camera image into a 3D coordinate system associated with a monitored area; and using the trained model to generate a set of calibration parameters.

In certain example embodiments, the method further includes applying the set of calibration parameters to at least one camera.

In certain example embodiments, the trained model and a backward trained model are obtained by: collecting images with known positions; training the trained model using the neural radiance field; obtaining approximate positions of at least one camera in the monitored area; generating training data using the trained model for each camera; and training the backward model for each camera, the backward model using the neural radiance field.

In certain example embodiments, the method further includes defining a spanned space for training.

In certain example embodiments, the set of calibration parameters is generated by: collecting pairs of points; and calculating calibration matrices for each camera.

In certain example embodiments, the monitored area comprises any one of a retail store, a logistic yard, a warehouse, and a manufacturing facility.

In certain example embodiments, the method further includes recalibrating by: acquiring an image from a given camera; determine an image validation to determine if valid; and when valid, perform a camera change detection.

In certain example embodiments, the method further includes, when the camera position has not changed: fine-tuning the trained model; and fine-tuning the trained backward model.

In certain example embodiments, the method further includes, when the camera position has changed: retaining the trained backward model; collecting pairs of points; recalculating a calibration matrix for the given camera; and fine tuning the trained model.

In certain example embodiments, the method further includes using the trained backward model to detect whether a camera position and/or orientation has changed.

In certain example embodiments, the backward model is trained by: determining an approximate position and angle of each camera; using the approximate position and angle of each camera to derive a probability density function to randomly sample training data on a sampling space for that camera.

In certain example embodiments, the neural radiance field comprises synthesizing views by learning a volumetric scene function of 3D positions and viewing directions.

In certain example embodiments, learning the volumetric scene function utilizes a multi-layer perceptron.

In another aspect, there is provided a computer readable medium storing computer-executable instructions for calibrating cameras deployed at monitored areas, comprising instructions for: obtaining a trained model, the trained model having been trained using a neural radiance field, the trained model back projects pixels in a camera image into a 3D coordinate system associated with a monitored area; and using the trained model to generate a set of calibration parameters.

In another aspect, there is provided a computing system comprising a processor and memory, the memory storing computer executable instructions that when executed by the processor, cause the system to: obtain a trained model, the trained model having been trained using a neural radiance field, the trained model back projects pixels in a camera image into a 3D coordinate system associated with a monitored area; and use the trained model to generate a set of calibration parameters.

### BRIEF DESCRIPTION OF THE DRAWINGS

Embodiments will now be described with reference to the appended drawings wherein:

FIG. 1 is an example of a computing environment in which an automated camera system may be deployed with a number of cameras.

FIG. 2 is a block diagram of an example of a configuration for an auto calibration module.

FIG. 3 is a flow chart illustrating example operations executed in performing an auto camera calibration.

FIG. 4 illustrates a backward NeRF multi-layer perceptron (MLP) process.

FIG. 5 is a flow chart illustrating example operations executed in performing fine tuning and retraining NeRF and backward NeRF.

FIG. 6 illustrates Algorithm 1 for backward NeRF training.

FIG. 7 is a block diagram of an example of a configuration for an auto placement module.

FIG. 8 is a flow chart illustrating example operations executed in performing an automated camera placement process.

FIG. 9 illustrates how the field of view of a camera is split into rays over two axes.

FIG. 10 illustrates how an emitted ray is split into segments, and how an object blocks a segment which then the values of σ are obtained.

FIG. 11 shows how average of sample points belonging to a segment are converted into a vector and a distance measure.

FIG. 12 illustrates how the 3D feature map is formed by collected data from rays and their segments.

FIG. 13 shows an end-to-end deep learning pipeline for the automated camera placement process.

### DETAILED DESCRIPTION

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

Recent advancements in artificial intelligence (AI) have led to significant improvements in the detection, recognition, and tracking of objects, achieving a high level of reliability and accuracy.

Despite the promising applications of computer vision algorithms in retail environments, a major hurdle in fully using AI's capabilities is the necessity for camera calibration parameters. These parameters are required for estimating the position of objects in the world coordinate system or in a coordinate system specific to the covered facility. Existing approaches for camera calibration are labor-intensive and financially burdensome, especially considering that a retail store can have many (e.g., between 100 to 200) cameras, and a logistics center may have several hundred cameras. This challenge severely makes the scalability of computer vision solutions difficult, casting doubt on their real-world utility.

In addition to the challenge of mass camera calibration, re-calibrating cameras is another issue, which can be even more costly for businesses. Over time, camera viewing angles may change, whether due to minor contact with other objects or adjustments in camera coverage areas, or environmental effects (i.e., wind). Typically, trained technicians need to be dispatched to the location, equipped with tools and equipment, to carry out the re-calibration. This requirement not only impedes scalability but also renders the maintenance of computer vision AI-based solutions impractical.

Some efforts have been made to address the camera calibration requirements for stationary and moving cameras based on traditional methods [3], [4], [5]. These methods are dependent on special setup and configuration which must be performed by a trained technician.

Therefore, the adoption of AI-based technology to address camera calibration and re-calibration is greatly sought after to achieve scalability and facilitate the easy maintenance of computer vision-based solutions.

The following presents a novel algorithm to automate the process of camera calibration. The described algorithm is particularly advantageous for applications dealing with many cameras where the conventional camera calibration methods become inefficient or even infeasible. The described algorithm receives an approximate location and orientation of the camera as the inputs and finds the accurate pose of the camera. The algorithm may leverage Neural Radiance Field (NeRF) to train a 3D representative model of the facility. Then, the method may use the model to train a novel backward NeRF model, that for a given camera image and an approximate pose of the image, it provides a list of corresponding points in 2D coordinate system of the camera and voxels in 3D coordinate system of the facility. The set of corresponding points and voxels are then used to find the projection matrix of the camera.

The following also provides an approach to the problem of optimizing a multi-camera system's coverage. Camera placement algorithms involve determining the optimal positions and orientations for cameras to cover a scene or object effectively. A family of problems related to coverage in the context of multi-camera systems have been studied. The following addresses the camera placement problem where the goal is to determine the optimal number and positioning of cameras to cover a facility. In the most general case, the facility to be observed by cameras might have an arbitrary volumetric shape. It may be an open space, or a blend of both, e.g., outdoors vs. Indoors. A novel deep-learning-based method is also described, that utilizes NeRF to suggest camera placements for a volumetric region. The approach takes into consideration the best view direction for the points of interest and their importance.

### Automated Camera System

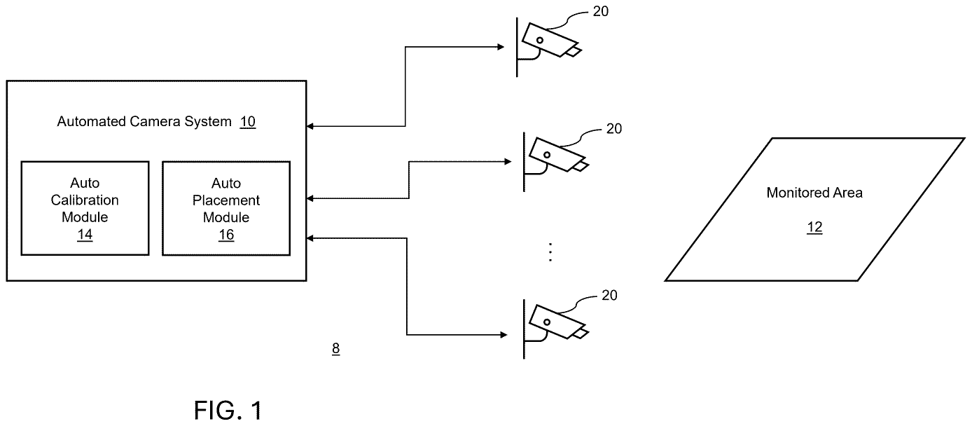

Referring now to the figures, FIG. 1 illustrates a computing environment 8 that may be integrated into a real-world facility or other area that utilizes monitoring via imaging devices. In this example, an automated camera system 10 is used to perform automated or automatic calibration using an auto calibration module 14 and to perform automated or automatic camera placement using an auto placement module 16. The automated camera system 10 is coupled to one or more cameras 20, with an arbitrary number of cameras 20 shown in FIG. 1 for illustrative purposes. The cameras 20 are used to capture images and/or video of a monitored area 12.

The automated camera system 10 may be configured within an embedded device or other computing device having a processor, memory, and interfaces for external communications (e.g., a data interface) and interfaces for communicating with the cameras 20. The automated camera system 10 may also include a network interface to permit electronic communications over a short- or long-range communication protocol as is known in the art.

### Automated Camera Calibration

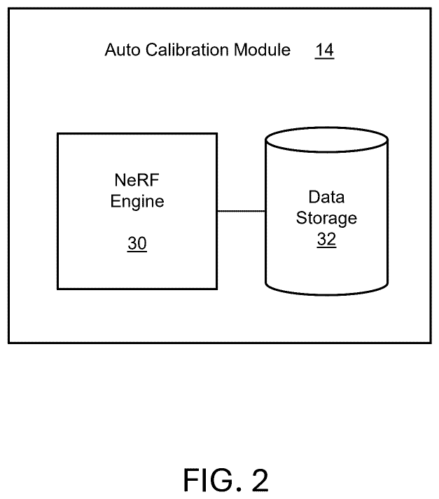

Referring to FIG. 2, shown is a configuration for the auto calibration module 14 utilized by the automated camera system 10. The auto calibration module 14 includes a NeRF engine 30 that may be configured to perform NeRF and backward NeRF operations as described herein and includes a data storage 32 for caching or storing data such as images, metadata, calibration data, parameters, etc. as needed by the module 14.

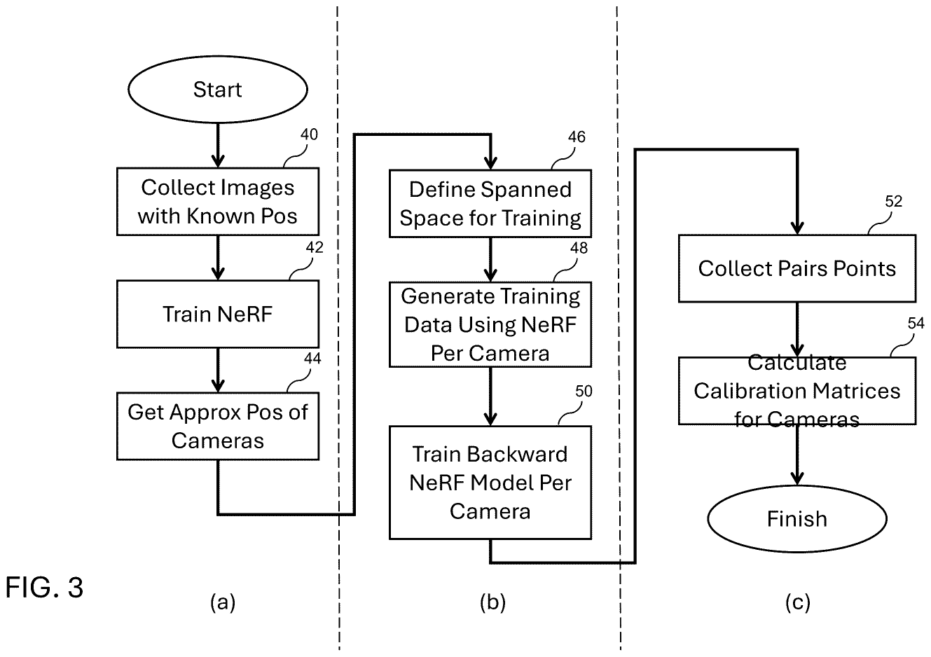

Referring to FIG. 3, the system 10 and module 14 may use a set of collected images (step 40) with any camera 20, while for each image the intrinsic and extrinsic parameters of the camera 20 are known, to train a 3D representation of a facility of interest (i.e., monitored area 12) using NeRF (step 42). The trained NeRF model provides 2D images from any novel viewing angle in the facility, as shown in FIG. 3, part (a).

For automated calibration of the cameras, the user first specifies an approximate position/angle for each camera 20 (step 44). This initial pose of the camera 20 is then used to sample in 3D space using the NeRF model (step 46), and these samples are used to train (step 48) a novel deep learning model that acts as a backward NeRF regressor (step 50) as shown in FIG. 1, part (b).

This regressor estimates the 3D position corresponding to each point of interest in the 2D camera image. The collected pair points (step 52), that is the 2D position of a point in the camera's view and its corresponding 3D position in the facility's coordinate system, may be used to calibrate the camera by calculating its calibration matrix (step 24) as shown in FIG. 1, part (c).

### Terminology Definition

The following discussion may refer to the monitored area 12, under coverage by the camera(s) 20 as a “facility” which can be a logistic center's yard or warehouse, a retail store, or a manufacturing space covered by cameras 20, to name a few. The following also uses “forward NeRF model” as a trained deep learning model using NeRF 30 that renders 2D images of any point of view in the facility, and “backward NeRF model” as a trained deep learning model that receives a set of neighbor pixels and its corresponding camera position as its inputs and estimates the corresponding point in the facility cartesian coordinate system.

A real camera in the facility is defined as Cᵢ, and its calibration parameters are defined based on its projection matrix as Projᵢ∈ [symbol] ^{3x4}. A camera image is referred as Iⱼ∈ [symbol] ^{w}^{ᵢ}^{×h}^{ᵢ}. The coordinate of a pixel inside the camera Cᵢ is defined as \vec{U}ⱼ=[uⱼ,vⱼ]^{T}, where uⱼ∈[0,wᵢ) and vⱼ∈[0,hᵢ) are along the horizontal and vertical axes of the image, respectively, and cᵢ(u,v) is the pixel's color in the RGB format. The corresponding point in the Cartesian coordinate system of the facility is defined as \vec{X}ᵢⱼ=[xᵢⱼ,yᵢⱼ,zᵢⱼ], and xᵢⱼ∈(xₘᵢₙ,xₘₐₓ),yᵢⱼ∈(yₘᵢₙ,yₘₐₓ), and zᵢⱼ∈(zₘᵢₙ,zₘₐₓ). A patch in the camera image, Iⱼ, with a radius rₚ, Pchᵢⱼ, is a subset of pixels defined as CPchᵢⱼ=[cⱼ₋ₖ, . . . , cⱼ₋₁, cⱼ, cⱼ₊₁, . . . , cⱼ₊ₖ] with coordinate of pixels as UPchᵢⱼ=[(uⱼ−rₚ,vⱼ−rₚ), (uⱼ−rₚ+1,vⱼ−rₚ), . . . , (uⱼ,vⱼ), . . . , (uⱼ+rₚ−1, vⱼ+rₚ),(uⱼ+rₚ,vⱼ+rₚ)], which [uⱼ,vⱼ]^{T} is the patch's center in the camera Cᵢ coordinate system, and k=2rₚ(rₚ+1).

### Camera Calibration:

### Introduction

Accurate camera calibration is of high importance in computer vision applications. Calibrating cameras 20 and detecting distortions pose significant challenges, especially when 3D models of the facility are unavailable or when uncalibrated cameras 20 are difficult to identify. In the following, a novel solution is presented to address the problem of camera calibration utilizing NeRF 30 and its inverse variant, named “Backward NeRF”. The method aims to accurately determine the correct camera positions in these challenging scenarios.

Existing approaches to camera calibration [6][7] are often limited in their effectiveness and they are labor intensive. This makes the process to be impractical once trying to apply it for a retail store or logistic center with many cameras. The described method provides an automated solution that provides an easy tool for ensuring precise camera calibration in retail stores and logistic centers.

### Method:

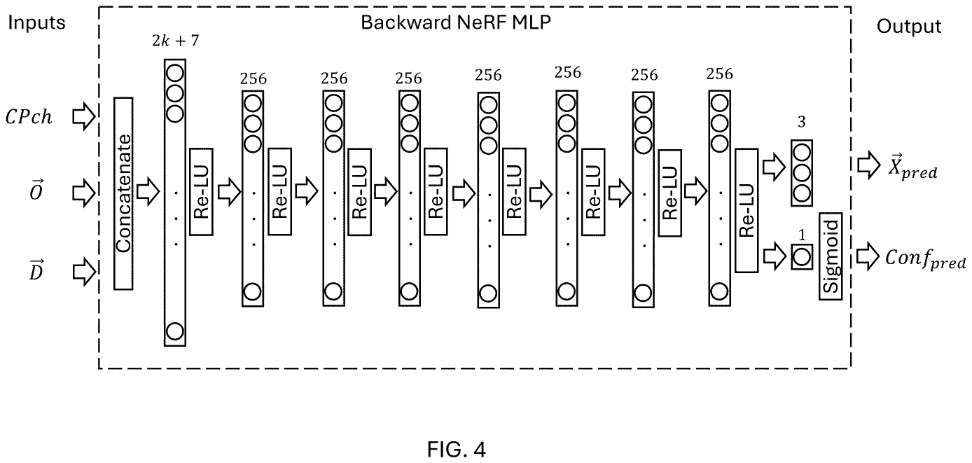

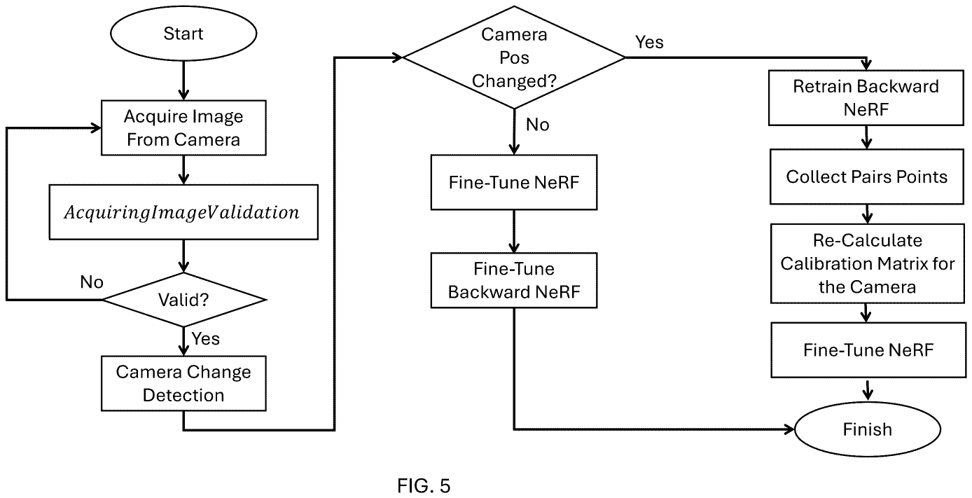

One may use 2D images captured from the facility to train a NeRF model that provides its 3D representation. For each captured image, its camera's intrinsic and extrinsic parameters are given. The trained NeRF model is then used to render 2D images from viewpoints of interest in the facility without having actual cameras there. To calibrate each existing camera in the facility, a user can specify an approximate position and view angle for it. The proposed solution uses this approximate information along with a captured image from the camera and feeds them to the backward NeRF model to estimate corresponding points in the camera image and world coordinate system. The backward NeRF process is illustrated in FIG. 4. A process for fine-tuning and retraining the NeRF and backward NeRF is shown in FIG. 5.

For each existing camera, a searching space of camera's parameters is defined. Then, using the trained NeRF, training samples are randomly collected until they adequately span the scene complexity. Each training sample includes a random camera position/orientation, and a set of rendered pixels around a given pixel and its correspondence in the world coordinate system. The training samples are then used to train the backward NeRF model.

These viewpoints may be represented by their 3D coordinates and orientations (camera poses). They system 10 may get these camera positions by approximated values. Then, the system 10 spans the space for training. As such, the system 10 has the color of the image points and the camera positions, as well as the value of calibration. Then, a deep neural network (DNN) can be used to learn to map this input to a point in the image.

### Non-Stationary Object Detection:

While collecting images for training and finetuning models, the system 10 can ensure that images are collected once moving objects are not in the scene. For example, in a retail store, images must be taken at the moments that no human or shopping card is inside. As another example, in the backyard of a logistic center, training images must be collected once no human or moving vehicle is in the scene. This process is named AcquiringlmageValidation (see FIG. 5). One may assume computer vision tools to detect objects like people, shopping cards, and vehicles are available to run after the first calibration and setup process are completed.

### 3D Representation of the Facility:

NeRF is a technique for rendering 3D scenes. NeRF has enabled the creation of high-quality visualization that are difficult or impossible to achieve using traditional rendering methods. The key idea is to synthesize novel views by learning volumetric scene function of 3D position and viewing direction (i.e., radiance fields) with multi-layer perceptron (MLP) as shown in FIG. 4.

The first step in training is to feed the MLP with a 3D location X=(x,y,z) of the input images of the scene from different viewpoints as well as 2D viewing direction (θ,φ). This training data is set for modeling the relationship between the 3D geometry and appearance of the scene as Equation 1 represents.

$${f}_{N e R F} ( x , θ , ϕ ) \to ( c , σ ) \qquad ( 1 )$$

Once training is finished, the trained NeRF model is used to render new views of the scene from arbitrary viewpoints. NeRF may experience bottlenecks like slow training and rendering process. Therefore, the follow up works have been proposed to adopt novel methods to address these bottlenecks, for instance Instant-NGP [10].

The present method begins with the utilization of 2D images captured within the store environment to train the NeRF model, enabling the generation of a comprehensive 3D representation of the store. During the inference stage, we provide the model with camera pose information, yielding either novel views or a complete 3D reconstruction.

### Backward NeRF:

Since the calibration process of each camera is independent from the other cameras, we train a backward NeRF per camera, and name it f_{BNeRF}.

To initiate the process of training backward NeRF as shown in FIG. 4, an approximate position and angle of each camera is needed which are defined as Õ_{ι} (optical center) and [symbol] (view angle), respectively. The approximate position and angle of each camera are used to derive a probability density function, PDFᵢ( [symbol] , [symbol] ), to randomly sample training data on a sampling space for that camera. The sampling space is a 6 DOF space that spans all the possibilities of camera placement inside the facility.

Random sampling is selected to ensure that the trained model is not biased toward specific camera alignment and helps avoid the overfitting problem during the training process. The density function specifies the possibility of randomly selecting a position and angle for a camera to generate training samples. The density function is generated using gaussian distribution as, PDFᵢ˜Gaussian([ [symbol] , [symbol] ]^{T},Σ), so that it gets high values around the approximate camera position, defined as [ [symbol] , [symbol] ]^{T}, and distributed by a standard deviation matrix, Σ. For the sake of simplicity, it is set as Σ=σ·eye(6).

The randomly generated camera position and angle are, \vec{O}ᵣ and \vec{D}ᵣ, respectively. For each random sample generation, a patch, Pchᵢⱼ, centered at \vec{U}ⱼ is randomly selected with a uniform distribution from the inside camera image domain as, \vec{U}ⱼ∈Uniform([rₚ,wᵢ−rₚ], [rₚ,hᵢ−rₚ]).

The trained NeRF model is used to generate CPchᵢⱼ for the novel view {\vec{O}ᵣ,\vec{D}ᵣ}. The use of NeRF model is necessary to generate training data for the backward NeRF model.

The backward NeRF model may include an MLP network which receives three inputs as CPch (a patch of the camera image), \vec{O}, and \vec{D}, and outputs \vec{X} and Conf which are corresponding point to the patch center point, \vec{U}, in the world coordinate system and confidence score of estimating \vec{X}, respectively.

The system 10 then uses the same number of layers (e.g., 9 layers) as NeRF 30 and each hidden layer has 256 channels, except the first layer has 2 k+7 channels to accommodate the scale of input patch, CPch∈ [symbol] ^{2k+1}, camera position \vec{O}∈ [symbol] ³, and camera angle, \vec{D}∈ [symbol] ³, and the last layer which has three channels to match the size of output. The Re-LU activation function is selected for the hidden layers, and no-activation is selected for the output layer to ensure the output can span the facility coordinate system. The number of trainable weights of the model is (2 k+8)×(2 k+7)+(257×256×6)+257×3=4 k²+30 k+395579. For example, for a patch size of 15×15, rₚ=7, and k=112, the total number of trainable weights is 449115.

The backward NeRF model is trained with rendered data generated by the trained forward NeRF, and it will get bias to the NeRF representation of the facility and may not work with an image acquired by an actual camera. To avoid overfitting to the NeRF space, the system 10 may add random noise component to the CPch with a random magnitude as Noise E [symbol] ^{2k+1}˜Uniform(−Mₙₒᵢₛₑ, Mₙₒᵢₛₑ) and Mₙₒᵢₛₑ˜Uniform(0,maxₙₒᵢₛₑ). Then, for each patch, a random noise component is generated and added to it before feeding the trainer. Also, we define a confidence score, conf, that is defined based on the noise magnitude as Conf=exp(−Mₙₒᵢₛₑ).

One may define two losses, one for \vec{X}, and one for Conf. For the first one, the system 10 uses the mean square error (mse) loss function but multiplied by the Conf value. The reason for this is that the system 10 wants to pass lower Gradient values for noisier inputs. So, the first loss function is defined as,

$${Loss}_{X} = Conf \cdot mse ( \vec{X} , {\vec{X}}_{p r e d} ) \qquad ( 2 )$$

where \vec{X}_{pred} is the predicted first output of the backward NeRF model. The second loss function is applied on the Conf as follows,

$${Loss}_{C o n f} = m s e ( Conf , {Conf}_{p r e d} ) \qquad ( 3 )$$

where Conf_{pred} is the predicted second output of the backward NeRF model.

For training the backward NeRF, a data generator module is developed that generates B training data per batch (batch_size=B), and for each data sample, it randomly selects a camera position and angle, {\vec{O}ᵣ,\vec{D}ᵣ}, and then, it randomly selects a pixel as the patch center, and it runs the trained NeRF model to get colors of pixels inside the patch. The training process is based on iterations, and it is not based on epochs.

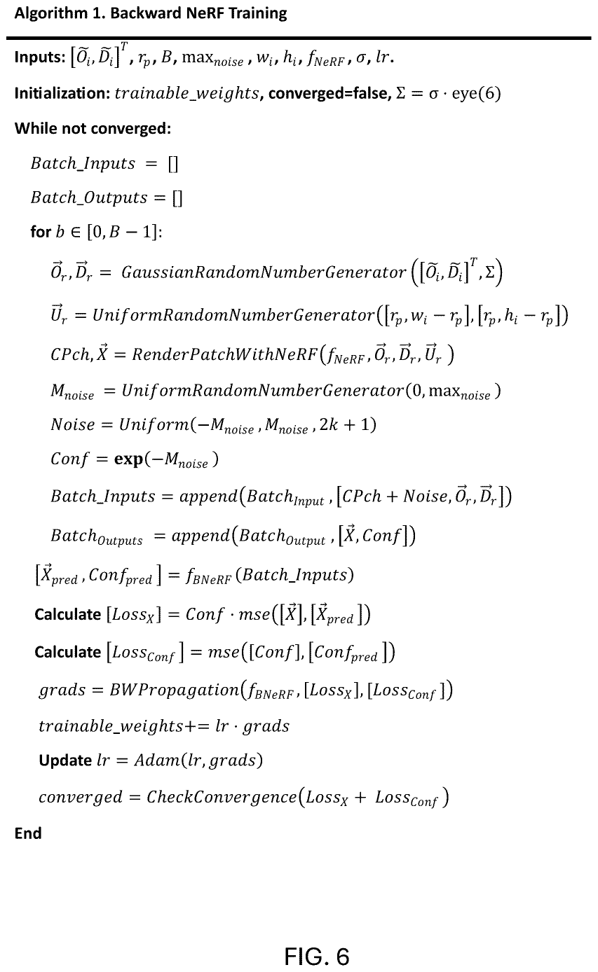

For each camera, the system trains a dedicated backward NeRF model. The system 10 assumes camera resolution and its intrinsic parameters are known. Therefore, the system 10 may use the same parameters to render patches using the trained NeRF inference. Each model is trained through iterations until it meets a convergence criterion (total loss not improving for 1000 iterations). Following the original NeRF implementation, the system 10 may use the Adam optimizer with a learning rate which starts from 5×10⁻⁴. The training algorithm is provided in Algorithm 1 shown in FIG. 6.

### Camera Change Detection:

Referring to FIG. 5, it may be a common issue in the use of computer vision in working environments that the position and orientation of cameras either planned or unintentionally change. Computer vision algorithms, especially those which are based on localizing and tracking objects, are highly dependent on the camera calibration, and once the camera's position or orientation changes, the camera calibration parameters become invalid and needs to be recalibrated. Also, blocking the lens or lens getting dirty are two other common issues. But the main problem is that the system 10 may not know the change in the camera, and it continues its scheduled operation which may result in wrong decisions that the system 10 takes until someone notices and reports the wrong operation of the system 10.

Here, a new algorithm is reported that utilizes the trained backward NeRF outputs to detect camera change incidents. For a camera, Cᵢ, all its patches are extracted by a unit stride, {CPchⱼ}. Given the expected camera position and orientation, \vec{o}ᵢ and \vec{D}ᵢ, respectively, the patches are fed to the trained backward NeRF model, f_{BNeRF}, and the confidence outputs, {Conf_{pred},i}, are collected. If the camera position and orientation are not changed from the setting that the model was trained with, we expect a portion of the confidence score to be higher than a threshold value. This is formulated as:

$$CameraUnchangedScore = {\sum }_{c o n f ∈ \{ C o n {f}_{p r e d} \}} ( c o n f > t {h}_{c o n f} ) \qquad ( 4 )$$

If the CameraUnchangedScore>th_unchng, then the decision is that the camera 20 has not changed, and otherwise, the camera 20 is changed. The reason for selecting this approach is that if objects in the scene change but not the camera position and orientation, then there should be a region in the scene that remained unchanged (ex: in a retail store, items in shelves have changed but shelves are remained unchanged), and therefore, there must be some patches in the camera image that matches with the trained backward NeRF model and for those patches, the model returns a high confidence value. Therefore, having several high confidence values means the camera position and orientation has not changed. Also, the AcquiringlmageValidation is applied to select a camera image for change detection to ensure no moving object is in the scene.

### Fine-Tuning NeRF and Backward NeRF Models:

In a facility, the orientation and direction of cameras can undergo changes due to various circumstances. Furthermore, objects within the facility may exhibit movement or alterations over time, such as items on a shelf changing positions. It is important to note that certain object-related changes, like new spills or human activity, do not necessitate fine-tuning of the NeRF model. Consequently, prior to making decisions regarding alterations in the scene, the system 10 employs the “AcquiringImageValidation” process to validate whether the changes in objects are legitimate. To accurately capture and project these scene modifications, and in the event of a change in a camera's direction, allowing it to capture new images beyond its current field of view, the system 10 may continually refine its NeRF model to maintain an up-to-date 3D representation of the scene. When there are changes in the camera's orientation or position, coupled with alterations in the colors of the scene points captured by the camera, the system 10 may initiate a comprehensive retraining of the Backward NeRF model. Subsequently, the system 10 can fine-tuned the NeRF model using the newly obtained camera orientation and position. However, if the camera remains stationary and only the scene information has changed, system 10 may fine-tune the Backward NeRF model.

### Camera Calibration:

Now that for each camera, a dedicated f_{BNeRF} is trained, the system 10 can use it to generate a set of correspondences on the camera image and the world coordinate systems, {\vec{U},\vec{X}_{pred},Conf_{pred}}. To do so, the camera image is split into patches with the same rₚ provided to the training process, and with a stride of rₚ, which results in patch extraction with 50% overlapping. The set of correspondences is then used to calculate the projection matrix [X], Projᵢ, for the camera Cᵢ[8].

### Camera Re-Calibration:

The trained backward NeRF model for each camera can be stored and can be used every while to generate correspondence in camera image and 3D coordinate system attached to the facility. The correspondence data can then be used to re-calibrate the cameras 20.

### Automatic Camera Positioning

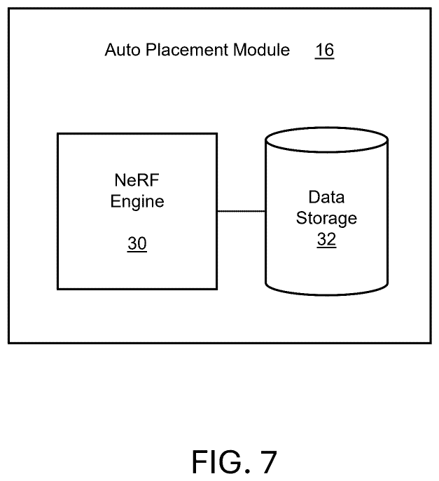

Referring now to FIG. 7, the auto placement module 16 is shown, which may also include a NeRF engine 30 (or share with module 14), and a data storage 32 (which may alternatively be shared, at least in part with module 14).

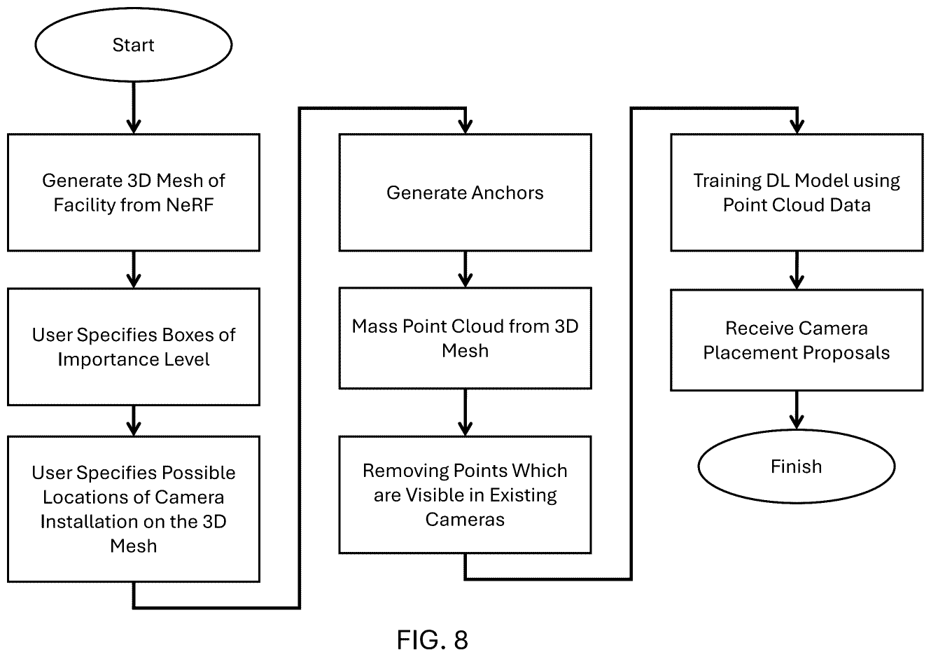

Referring to FIG. 8, this figure shows the overall pipeline of automated camera placement process, which may be performed by the auto placement module 16. As shown, a NeRF model representing the 3D model of the facility for automated camera placement is needed. The method starts with initial anchors and updates them through training iterations to converge into final camera placement proposals as will now be described.

### Process Flow:

A 3D mesh model of the facility may be generated from the trained NeRF model. The 3D model is used for three purposes in this example, including:

1) A user can be asked to specify high importance regions by drawing boxes around the regions and specifying their importance levels. That needs a 3D visualization of the facility that the user can add boxes to it.

2) A user can be asked to specify possible locations of camera installation on the 3D model of the facility, so that the algorithm takes it as input to specify candidate locations of placing cameras.

3) The 3D model of the store is used to generate a set of points inside the facility, referred to a point cloud.

Once the user specifies possible locations of placing cameras 20, the algorithm specifies candidate camera placements. Herein each candidate may be referred to as an “Anchor”. Each anchor has 6 parameters including, x, y, z, θₓ, θ_{y}, and θ_{z}. Anchors are placed on possible locations with a configurable parameter, stride.

For each existing camera 20 with a known calibration, system 10 may emit rays and remove points in the point cloud that are represented by camera 20. Therefore, points which are visible on existing cameras 20 are removed from the point cloud. Once the point cloud is refined, it is fed to a DL training process after training is finished, it provides an optimal number of cameras 20 with their location and orientation to cover the blind spots in the facility as shown in FIG. 8.

### DNN-based Camera Placement

### Sampling:

In the previous section the disclosure describes the core components used for modelling the problem. The optimal camera placement problem is usually intractable in the continuous domain. Current approaches to solving camera placement usually deal with reducing the problem to a combinatorial optimization problem and incorporating heuristic and iterative algorithms to solve it. The following presents a deep learning-based algorithm that solves the camera placement problem. This section describes the overall architecture of the proposed neural network and the training methodology.

In the 3D representation of a facility, the number of point clouds can vary significantly and may often be substantial in quantity. Unlike 2D images, point clouds exhibit sparsity and disorder, posing challenges for robust data processing. Additionally, point clouds can include noisy data points. Unlike the application of traditional convolution operations in 2D image processing, working with unstructured point cloud data can require alternative approaches. Consequently, many current methods employ sampling techniques to select representative points from the original point clouds, facilitating localized feature learning. The system 10 employs Farthest Point Sampling (FPS) to sample I points in the 3D space. The FPS algorithm guarantees the sample points are far from each other, covering most of the space.

Each point has a feature of 3 positions, 2 camera directions, and importance. As a result, out of point cloud P, one has set S containing I sample points with features fᵢ∈ [symbol] ⁶.

In addition to considering the sample points themselves, it can be important to incorporate information from their neighboring nodes. This involves propagating the features of a sampled node's neighbors into the feature representation of the sampled node. This process allows for the aggregation of information from multiple nodes simultaneously, enabling more efficient information exchange and enhancing the learning process within the local neighborhood.

Therefore, for each sample point pᵢ, using KNN algorithm one may extract the K positionally nearest points to that sample. Therefore, matrix Pi:

$$p s = ( \begin{matrix}{p}_{1 , 1} & … & {p}_{1 , k} \\ ⋮ & ⋱ & ⋮ \\ {p}_{I , 1} & … & {p}_{I , k}\end{matrix} ) , {p}_{i} ∈ {ℝ}^{3} fij = \{ {f}_{11} , … , {f}_{k , j} ) ; \\ j \neq k and {f}_{i , j} ∈ {ℝ}^{6}$$

where fij is the feature vector of the j th neighbor point of sample point pᵢ and fᵢ is the feature vector of ith sample point.

Inspiring the Graph Attention Network, the system 10 may produce a new set of node features using the features of neighbor points to each sample point. These new features are

$${f}_{i}^{′}$$

∈ [symbol] ^{D} where D is the new and different cardinality. To weigh the importance of each neighborhood, one may perform self-attention for each sample point. For point i and its neighbor point j:

$${e}_{i , j} = a ( {Wf}_{i} , {Wf}_{j} )$$

Where a is shared attention mechanism and e_{i,j}∈ [symbol] is attention coefficient. Here a parametrized weight matrix, W∈ [symbol] ^{D,D} is used. It should be noted that the attention coefficients are computed only for a sample point and their K neighbors.

To make these attention coefficients comparable across different neighbor points, normalize it and can apply nonlinearity a to the attention mechanism:

$${α}_{i , j} = \frac{exp ( σ ( {W}_{a} [ {Wf}_{i} \vert {Wf}_{j} ] ) )}{{\sum }_{k ∈ \{ 1 , 2 … , K )} exp ( σ ( {W}_{a} [ {Wf}_{i} \vert {Wf}_{k} ] ) )}$$

Therefore, propagating the features of the neighbors into the sample point with respect to their importance:

$${f}_{i}^{′} = σ ( {\sum }_{j ∈ \{ 1 , 2 , … , K \}} {α}_{i , j} {Wf}_{j} )$$

To stabilize the learning process, use multi-head attention and average, to remove the concatenation. Also, apply nonlinearity as the final layer is the first stage of the network.

$${f}_{i}^{′} = σ ( \frac{1}{K} {\sum }_{k = 1}^{K} {\sum }_{j ∈ \{ 1 , 2 , … , K \}} {α}_{i , j}^{k} {W}^{k} {f}_{j} )$$

As a result, map each point cloud to I sample points with new features. The output is F′∈ [symbol] ^{D}. Preserving the importance of individual points is paramount. When altering the dimensionality of features and mapping them to another space, it can be important to include the average importance of a sample point and its k neighbors in the final feature representation. This results in features denoted as

$${f}_{i}^{′}$$

### ∈R^{D+1}.

### Converting Point Cloud to Feature Maps

The sample point cloud data are in the 3D coordinate system that is attached to the facility. However, one may need another representation of the point cloud data that is bound to the projective space attached to each candidate camera, such that the deep learning model learns to translate coverages of point cloud data into camera position and orientation changes.

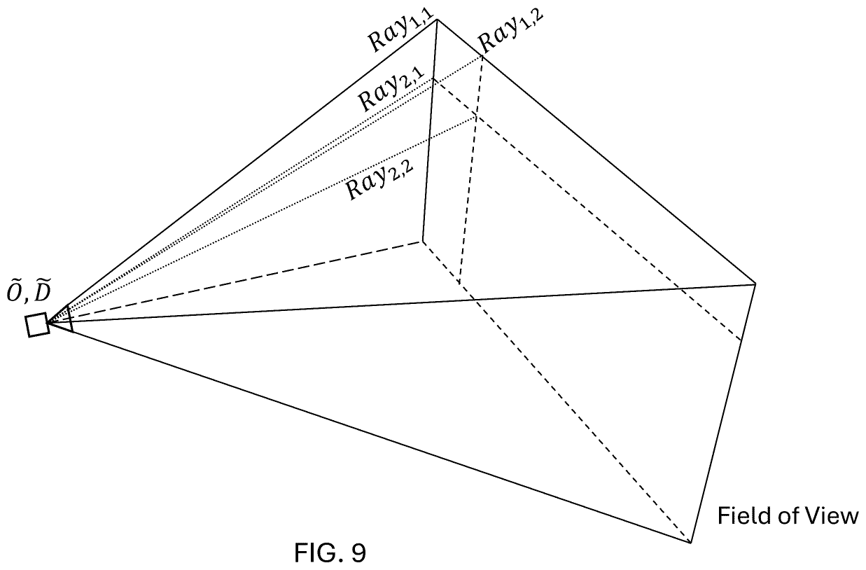

To achieve this purpose, for each candidate camera 20, with given Õ and \tilde{D}, Nᵣ×Nᵣ rays are transmitted from the optical center of the camera, Õ, covering the camera's field of view, as {ray_{u,v}}, which u, v∈[0,Nᵣ−1]. The centric ray, ray_{cent}=ray_{(N}_{ᵣ}_{-1)/2,(N}_{ᵣ}_{-1)/2} (see FIG. 9).

Each ray is then segmented from its near field, dₙₑₐᵣ, to its far field, d_{far}, into segments with fix length, d_{seg}, creating N_{seg}=(d_{far}−dₙₑₐᵣ)/d_{seg} segments. The total number of segments is

$${N}_{r}^{2} {N}_{s e g} ,$$

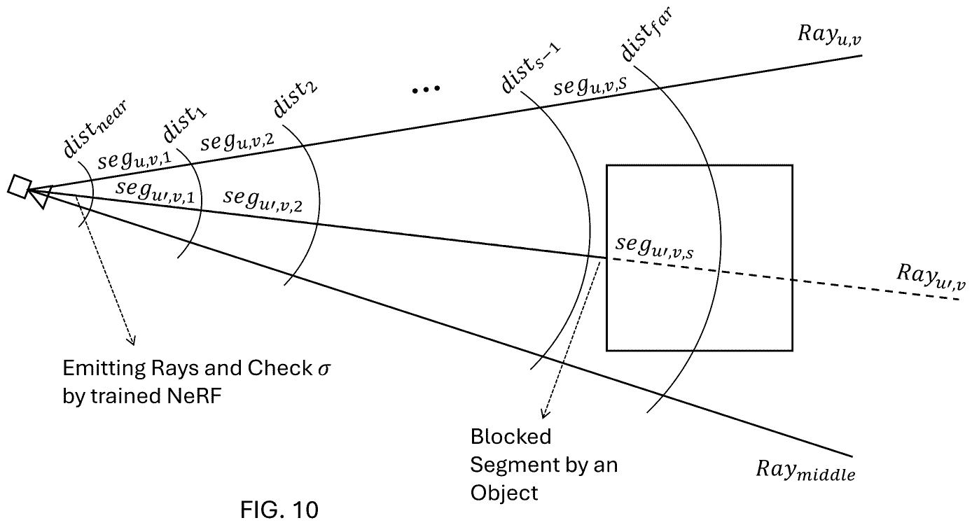

and each segment is Seg_{u,v,s} which s∈[0,N_{seg}−1]. Also, the middle point of each segment is, \vec{C}_{u,v,s}. For each ray, start from the first segment and calculate the density of each point on the ray using the trained NeRF model, and continue until hitting a point that σ reaches 1. Then, disable the proceeding segments of that ray, and the ignored segments are named as blocked segments (see FIG. 10).

For each point in the point cloud, its distances to all the segments are calculated, the point is assigned to a segment with the minimum distance. Also, set a threshold distance, Th_{SegAss}, to ensure far points are not assigned to the segment. However, the threshold value should not be small because then the optimizer would not be able to look sufficiently around the camera view to move toward optimal position and orientation to cover more points with higher importance in its neighborhood.

Empirically set Th_{SegAss}=2 (meters). Once the assignment process is done, for each non-blocked segment, the average feature vector of the assigned point clouds are calculated as

$${\vec{p}}_{u , v , s}^{{}_{avg}} and {\vec{f}}_{u , v , s}^{{}_{avg}} ,$$

which are the average position and average feature vectors of the assigned points, respectively. Also, the percentage of assigned points to the segment versus the total number of points is also computed as AssPerc_{u,v,s}, and average importance scores of the assigned points as AvgImp_{u,v,s}.

For each non-blocked segment, Seg_{u,v,s}, a unit vector is calculated which is in the direction of the corresponding segment in the centric ray's center point to its center point as,

$${\vec{V}}_{u , v , s}^{{}_{}} = \frac{{\vec{C}}_{u , v , s}^{{}_{}} - {\vec{C}}_{cent}^{{}_{}}}{‖ {\vec{C}}_{u , v , s}^{{}_{}} - {\vec{C}}_{cent}^{{}_{}} ‖}$$

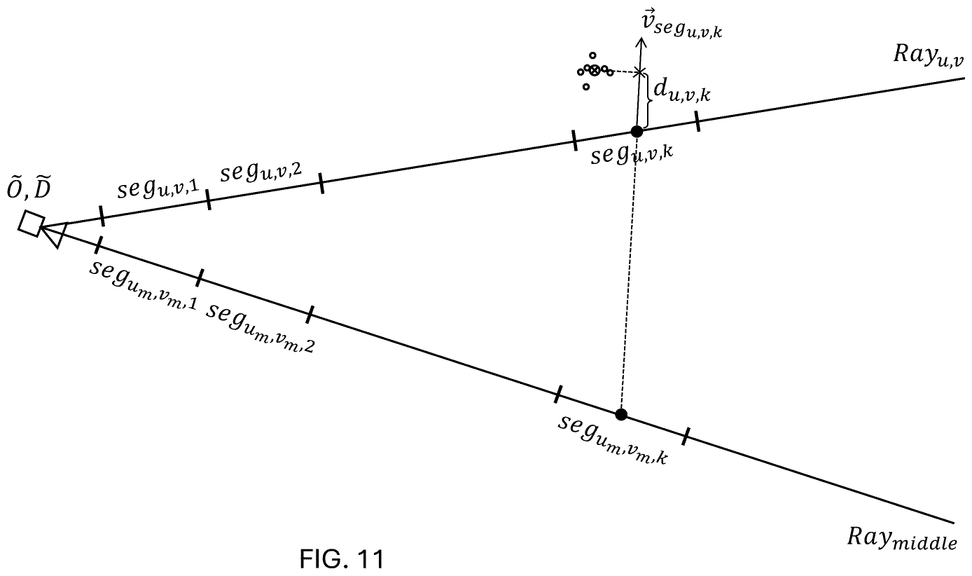

(see FIG. 11). The projection of

$${\vec{p}}_{u , v , s}^{{}_{avg}}$$

on the line, specified by \vec{V}_{u,v,s}, is calculated and the distance of the projected point to \vec{C}_{u,v,s} is computed as, dist_{u,v,s}.

Now, for each variable in the list of feature variables, including dist_{u,v,s}, each element of

$${\vec{f}}_{u , v , s}^{{}_{{}_{avg}}} ,$$

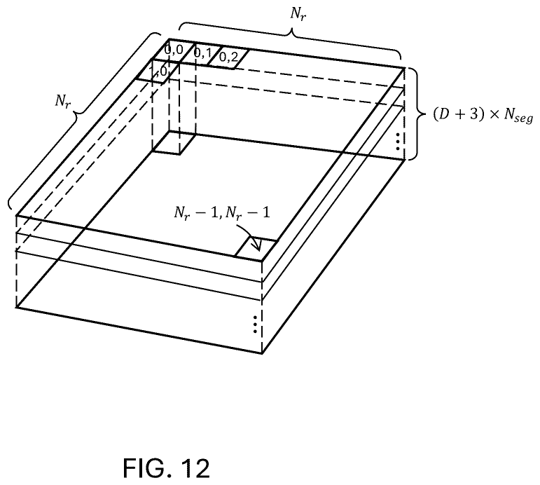

AssPerc_{u,v,s}, and AvgImp_{u,v,s}, which are D+3, a set of feature maps are created. For each feature variable, N_{seg} feature maps are created, in which each feature map is for a segment. Therefore, the total number of feature maps will be (D+3)×N_{seg}. Each feature map is in the size of Nᵣ×Nᵣ, as [symbol] where l∈[0,L−1], where L=(D+3)×N_{seg}−1 (see FIG. 12).

### Model

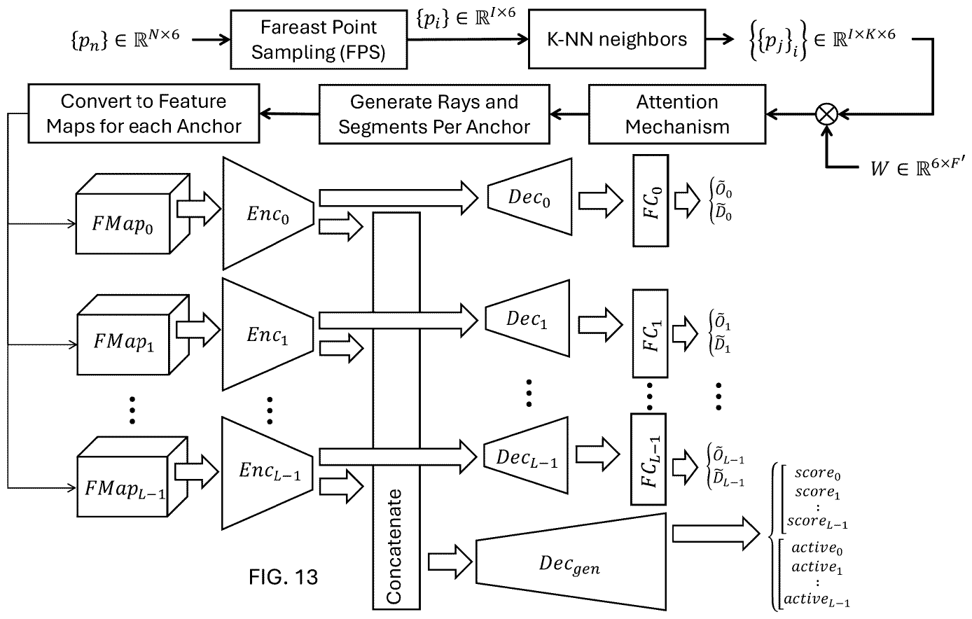

Referring now to FIG. 13, since the point cloud data is converted into feature maps per anchor, regular image based deep learning blocks become available, such as convolutional layer, average and max pooling, etc. The model is designed in a way that deep features are extracted from each anchor's feature maps separately, but in the final decision layers, all the anchors share their features so that a global optimum answer is reachable. Therefore, the network is comprised of two stages: (a) local feature extraction per anchor (local encoders), and (b) global regression and decision layers (decoder).

Each local encode is formed by three convolutional layers that extract coded information from the feature maps. The last layer is an average pooling layer that outputs N_{f} features. All the outputs of the local encoders are then concatenated to form the feature vector \vec{F}_{coder}∈ [symbol] ^{LN}^{_{f}}.

The decoder network includes multiple fully connected layers and receives the input feature vector, \vec{F}_{coder}, to process them all the features of the anchors together. The output of the decoder is a high-level feature vector, \vec{F}_{decoder}∈ [symbol] ^{miult}^{_{decoder}}^{N}^{_{anchors}}, Mult_{decoder} is a configurable multiplier. The number of neurons in the last fully connected layer (FC) of the decoder is proportional to the number of anchors, N_{anchors}, which is intuitive. Finally, the output of the decoder is connected to FCs to output anchors parameters. Each anchor output has eight parameters, including O∈ [symbol] ³, \tilde{D}∈ [symbol] ³, score, and active, which are the optical center, orientation, coverage score, and activeness of the anchor, respectively (see FIG. 13). FIG. 13, shows the end-to-end deep learning pipeline of automated camera placement process. The generated feature maps at each iteration is passed through an encoder-decoder network which then is passed through a fully connected layer to obtain updated position and orientation of each anchor. The score and activation value for each anchor is also obtained using a separated decoder head.

### Loss Function

The output of the training process is the camera placements solution. There is no ground truth data for training, and the training is based on a combination of self-supervised and unsupervised learning.

Three loss functions are engaged as (a) camera pose deviation from initial anchor pose, loss_{dev}, (b) cloud point coverage loss, loss_{cov}, and (c) camera activation loss, loss_{act}, and they are defined as follows,

$${loss}_{dev} = {\sum }_{c ∈ [ 0 , … , L - 1 ]} {f}_{dev} ( [ \begin{matrix}{Õ}_{c} - {Õ}_{c}^{0} \\ \tilde{{D}_{c}} - {\tilde{D}}_{c}^{0}\end{matrix} ] ; [ \begin{matrix}Δ \vec{O} \\ Δ \vec{D}\end{matrix} ] ) \qquad ( 5 )$$

$${f}_{d e v} ( x ; {x}^{0} ) = {\sum }_{i ∈ 6} \frac{{x}_{i}}{\vert {x}_{i} - {x}_{i}^{0} \vert} R e L U ( \vert {x}_{i} - {x}_{i}^{0} \vert ) \qquad ( 6 )$$

$${loss}_{c o v} = exp ( {( 1 - {\sum }_{c ∈ [ 0 , … , L - 1 ]} {active}_{c} \cdot {score}_{c} )}^{2} ) - 1 \qquad ( 7 )$$

$${loss}_{a c t} = {\sum }_{c ∈ [ 0 , … , L - 1 ]} {active}_{c} \qquad ( 8 )$$

Where unit(x) is the unit function that is one for x≥0.

$${Õ}_{c}^{0} and {\tilde{D}}_{c}^{{}_{0}}$$

are default center point and orientation of the c^{th} anchor.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the systems and computing environments described herein, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

### REFERENCES

[1] Mildenhall B, Srinivasan P P, Tancik M, Barron J T, Ramamoorthi R, Ng R, NeRF: Representing Scenes as Neural Radiance Fields for View Synthesis, Communications of the ACM, 65(1), pp. 99-106, 2021.
[2]F. D. L. N. i. Fisher J E, “Standard Cognition Corp, assignee. Realtime inventory tracking using deep learning”. U.S. Pat. No. 10,445,694, 2019.
[3]J. S. Kranski, F. D. Zyda, G. Vesom, G. S.-Y. Tsai, J. A. Grata, Z. Jia and L. Jiang, “Camera calibration system, target, and process”. U.S. Pat. No. 10,547,833, 28 Jan. 2020.
[4]H. Arora, Y. Xing, R. rzeszczuk, C.-K. Wang, P. R. dos Santos Mendonca and A. Sanat Kumar Dhua, “Camera calibration for augmented reality”. U.S. Ser. No. 10/839,557B1, 17 Nov. 2020.
[5]J. C. Curlander, G. Kimchi, B. J. O'Brien and J. L. Peacock, “Camera calibration using fixed calibration targets”. U.S. Pat. No. 9,986,233B1, 29 05 2018.
[6]Y. Zhang, “Camera calibration. In 3-D Computer Vision: Principles, Algorithms and Applications,” pp. pp. 37-65, 2023.
[7] Barreto J P, Araujo H, “Geometric properties of central catadioptric line images and their application in calibration,” IEEE Transactions on Pattern Analysis and Machine Intelligence, 2005.
[8]H. Bacakoglu and M. S. Kamel, “A three-step camera calibration method,” IEEE Transactions on Instrumentation and Measurement, vol. 46, no. 5, pp. 1165-1172, 1997.
[9]L. Rainer and E. Hörster, “On the optimal placement of multiple visual sensors,” in Proceedings of the 4th ACM international workshop on Video surveillance and sensor networks, 2006.
[10]Müller, Thomas, et al. “Instant neural graphics primitives with a multiresolution hash encoding.” ACM transactions on graphics (TOG) 41.4 (2022): 1-15.

1. A method of camera calibration for cameras deployed at monitored areas, the method comprising:
obtaining a trained model, the trained model having been trained using a neural radiance field, the trained model back projects pixels in a camera image into a 3D coordinate system associated with a monitored area; and
using the trained model to generate a set of calibration parameters.

2. The method of claim 1, further comprising applying the set of calibration parameters to at least one camera.

3. The method of claim 1, wherein the trained model and a backward trained model are obtained by:
collecting images with known positions;
training the trained model using the neural radiance field;
obtaining approximate positions of at least one camera in the monitored area;
generating training data using the trained model for each camera; and
training the backward model for each camera, the backward model using the neural radiance field.

4. The method of claim 3, further comprising defining a spanned space for training.

5. The method of claim 1, wherein the set of calibration parameters is generated by:
collecting pairs of points; and
calculating calibration matrices for each camera.

6. The method of claim 1, wherein the monitored area comprises any one of a retail store, a logistic yard, a warehouse, and a manufacturing facility.

7. The method of claim 1, further comprising recalibrating by:
acquiring an image from a given camera;
determine an image validation to determine if valid; and
when valid, perform a camera change detection.

8. The method of claim 7, further comprising, when the camera position has not changed:
fine-tuning the trained model; and
fine-tuning the trained backward model.

9. The method of claim 7, further comprising, when the camera position has changed:
retaining the trained backward model;
collecting pairs of points;
recalculating a calibration matrix for the given camera; and
fine tuning the trained model.

10. The method of claim 1, further comprising using the trained backward model to detect whether a camera position and/or orientation has changed.

11. The method of claim 1, wherein the backward model is trained by:
determining an approximate position and angle of each camera;
using the approximate position and angle of each camera to derive a probability density function to randomly sample training data on a sampling space for that camera.

12. The method of claim 1, wherein the neural radiance field comprises synthesizing views by learning a volumetric scene function of 3D positions and viewing directions.

13. The method of claim 12, wherein learning the volumetric scene function utilizes a multi-layer perceptron.

14. A computer readable medium storing computer-executable instructions for calibrating cameras deployed at monitored areas, comprising instructions for:
obtaining a trained model, the trained model having been trained using a neural radiance field, the trained model back projects pixels in a camera image into a 3D coordinate system associated with a monitored area; and
using the trained model to generate a set of calibration parameters.

15. A computing system comprising a processor and memory, the memory storing computer executable instructions that when executed by the processor, cause the system to:
obtain a trained model, the trained model having been trained using a neural radiance field, the trained model back projects pixels in a camera image into a 3D coordinate system associated with a monitored area; and
use the trained model to generate a set of calibration parameters.
